(19) United States
(12) Patent Application Publication
(10) Pub. No.: US 2002/0091612 A1
(43) Pub. Date: Jul. 11, 2002

(54) Method, system, and business method for providing a marketplace for computing capacity in a network

(75) Inventors: David P. Greene, Ossining, NY (US); Samuel Dinkin, Austin, TX (US); Paul A. Moskowitz, Yorktown Heights, NY (US); Stephen J. Boies, Mahopac, NY (US); Philip Shi-Lung Yu, Chappaqua, NY (US); William Grey, Millwood, NY (US)

Correspondence Address: Brian W. Brown, Morgan & Finnegan, L.L.P., 345 Park Avenue, New York, NY, 10154, US

(73) Assignee: International Business Machines Corporation, Armonk, NY (US)

(21) Appl. No.: 09/740,943

(22) Filed: Dec. 21, 2000

(51) Int. Cl. G06F 17/60

(52) U.S. Cl. 705/37

(57) ABSTRACT

A method, system, and business method are disclosed for providing a marketplace for computing capacity in a network. An indication of needed computing capacity, including a bid amount, and an indication of available excess computing capacity, including an ask amount, are received in the computing capacity marketplace server for a plurality of computers in the network. The method creates a computing capacity marketplace by matching the bid amount with the ask amount, thereby enabling one computer to provide at least a portion of its available computing capacity to another computer in response to the matching step.

### FIELD OF THE INVENTION

The invention disclosed broadly relates to computer networks and more particularly relates to providing a market place for computing capacity in a network.

### BACKGROUND

Many computers are used sporadically, with significant blocks of intervening idle time. Nights, weekends, and holidays are often predictable periods when computers are not being used. Many computers are purchased on credit and are not producing revenue during such idle periods, even though the interest on the loans for the computers accrues. Not only are commercial computers underutilized, but personal computers are typically used only a small fraction of the time. There is another side to computer capacity, those times when computers fall. The need for computing capacity to replace failed systems is not predictable. Outages typically occur at random times when the computer is needed for computationally intensive projects. Other types of computing capacity needs are more predictable, such as when a large payroll needs to be generated. What is needed is a marketplace for the buying and selling of available excess computing capacity.

### SUMMARY

The problems of the prior art are solved by the method, system, and business method disclosed for providing a marketplace for computing capacity in a network. The method can begin by receiving in the marketplace server, an indication of available excess computing capacity, including an ask amount, for a selling computer of the plurality of computers. The indication of available excess computing capacity can include a start time and an end time for delivery of the available excess computing capacity, and a quantity of the available excess computing capacity. The quantity of the available excess computing capacity can be an amount expressed in units of either floating point operations, web page views, or the like. The method continues by receiving in a marketplace server an indication of needed computing capacity, including a bid amount, for a buying computer of a plurality of computers in a network. The indication of needed computing capacity can include information such as a start time and an end time for delivery of the needed computing capacity, and a quantity of the needed computing capacity. The quantity of the needed computing capacity can be an amount expressed in units of either floating point operations, web page views, or other suitable units. The system and method can also be applied to needed storage capacity. The receipt of the buyer's indication of needed computing capacity can be either a real time bid in a spot market established by the server or a standing bid in the market established by the server. Then, the method continues by matching in the marketplace server the buying computer's bid amount with the selling computer's ask amount. In this manner, the marketplace server enables the selling computer to provide at least a portion of the available excess computing capacity to the buying computer in response to the matching step. To facilitate the formation of a marketplace for trading computing capacity, the system and method can provide membership status in the marketplace server for the plurality of member computers in the network. In this manner, the member computers can have previously provided the indication of needed computing capacity and the indication of available excess computing capacity to the marketplace server. The system and method can also provide a spot market for trading computing capacity, wherein the member computers provide the indication of needed computing capacity and the indication of available excess computing capacity on a real-time basis for spot market transactions.

### DESCRIPTION OF THE FIGURES

FIG. 1A is a network diagram showing the relationship between the computing capacity marketplace server and the computers in the network that will be sharing their excess computing capacity in a computing capacity marketplace.

FIG. 1B is a more detailed functional block diagram of the computing capacity marketplace server.

FIG. 2 is a flow diagram of the sequence of operational steps carried out by the market server.

FIG. 3 is a flow diagram of alternate sequence of operational steps carried out by the market server.

FIG. 4 is a flow diagram of the sequence of operational steps carried out by the marketplace server to match bid amounts to ask amounts.

FIG. 5 is a flow diagram of the sequence of operational steps carried out by the marketplace server to match multiple bid amounts to multiple ask amounts.

### DETAILED DESCRIPTION OF THE PREFERRED EMBODIMENT

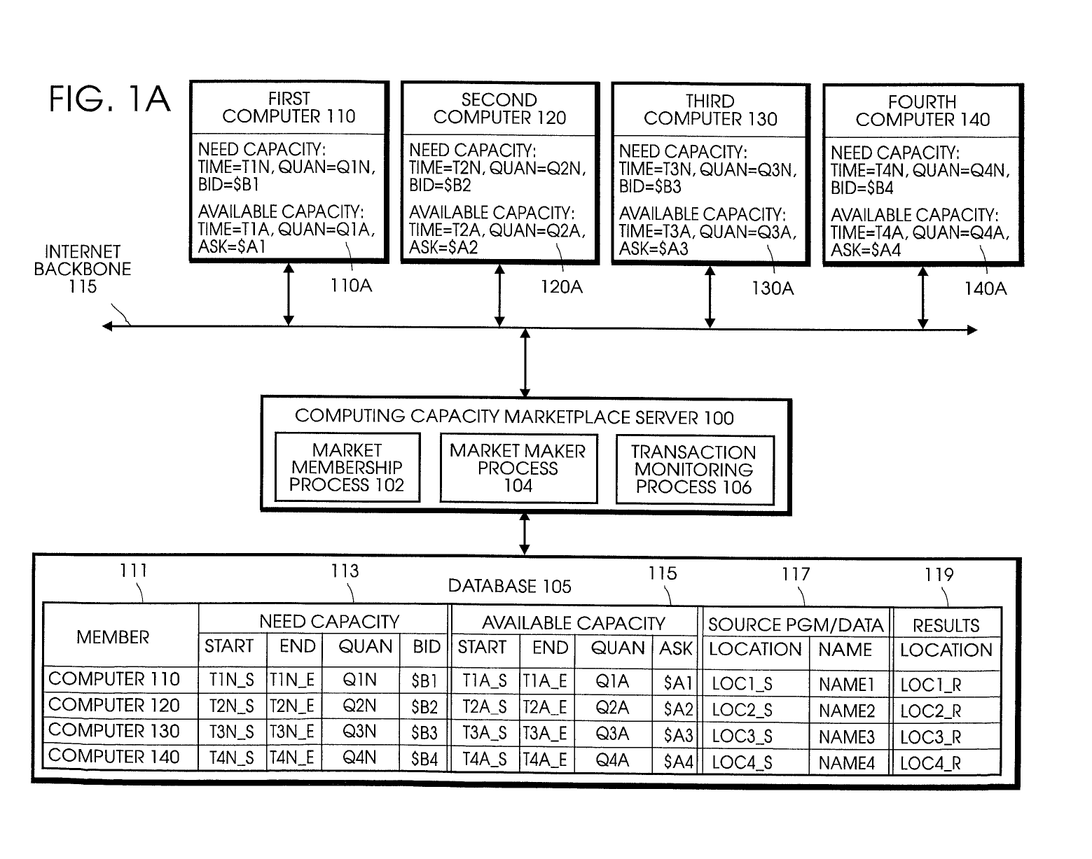

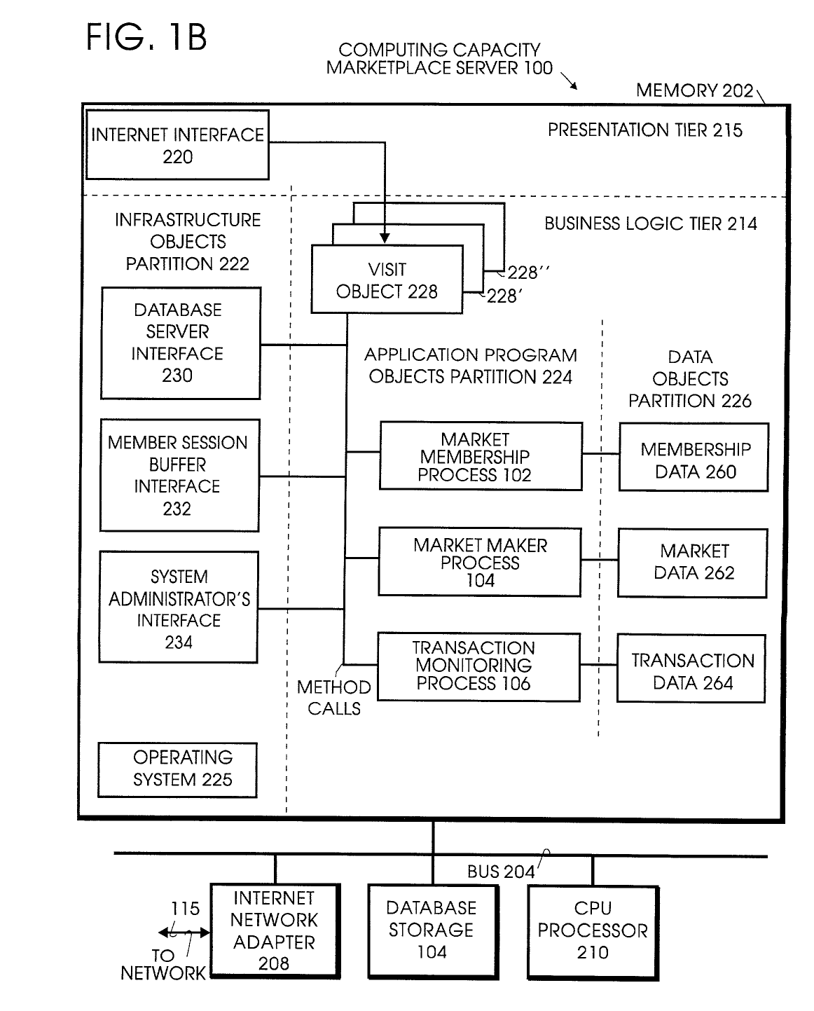

FIG. 1A is a network diagram, showing the relationship between the computing capacity marketplace server 100 and the computers 110, 120, 130, and 140 in the network that will be needing additional computing capacity, offering their available excess computing capacity, or both, in a computing capacity marketplace created in accordance with the preferred embodiment. The marketplace server 100 manages the database 105 which stores data for each of the member computers in the marketplace, such as, for example, the quantity of any computing capacity needed, the quantity of any available excess computing capacity, the times in which the identified computing capacity is needed, the times in which the identified excess computing capacity is available, the bid price for the identified quantity of computing capacity needed, the asking price for the use of the identified quantity of available excess computing capacity, the names and locations of any source programs and/or data files needed for computation, and the location where the results of any computations are to be stored.

In FIG. 1A, the first computer 110 is shown connected to the Internet backbone 115, which in turn is connected to the computing capacity marketplace server 100. Examples of network topologies and protocols suitable for the connection of the computers 110, 120, 130, and 140 over the Internet to the server 100 are described in the book by Daniel Minoli, et al., entitled “Internet Architectures,” published by John Wiley and Sons, 1999. The first computer 110 has a need for additional computing capacity, that is, there is a particular quantity of computing capacity that the first computer 110 needs, during a first time interval, and at a particular biding price for which computer 110 is willing to pay. Additionally, first computer 110 may also have a quantity of available excess computing capacity during a second time interval that may be offered to other computers in the network, that is, there is a particular quantity of computing capacity that first computer 110 has available, during the second time interval, and for a particular asking price. Additional information would also be provided to the computing capacity marketplace server 100 by the first computer 110 to allow the computing capacity marketplace server 100 to carryout any agreement the computing capacity marketplace server 100 establishes between the first computer 110 and other computers in the network. Information can be transmitted over the Internet backbone 115 from the computer 110 to the computing capacity marketplace server 100 in messages using the Hypertext Transfer Protocol (HTTP) on the worldwide web, File Transfer Protocol (FTP), or Electronic Mail Messaging. A description of these Internet protocols is given in the book by D. C. Naik, entitled “Internet Standards and Protocols,” published by Microsoft Press, 1998. For example, if the computing capacity marketplace server 100 successfully arranges for a computing capacity need of the first computer 110 to be provided for by the second computer 120, the second computer 120 would be unable to successfully fulfill its portion of the computing capacity agreement unless a pre-processing transfer of all necessary executable program code and/or data from the first computer 110 to the second computer 120. In order for the computing capacity marketplace server 100 to successfully perform such a pre-processing transfer, the first computer 110 would have to specify the location and name of the executable program code and/or data which the second computer 120 is to execute and/or process on behalf of the first computer 110. This is shown in the database 105 of FIG. 1A at 117. Upon completion of the agreed processing by the second computer 120, a post-processing transfer of all processed data from the second computer 120 to the first computer 110 would likewise need to be executed. In order for the computing capacity marketplace server 100 to successfully perform such a post-processing transfer, the first computer 110 would have to specify a location in the network where the second computer 120 would store the post-processed data for later access by the first computer 110. This is shown in the database 105 of FIG. 1A at 119. Transfer of program code and data between computers 110 and 120 can be done over the Internet backbone 115 using File Transfer Protocol (FTP), for example.

The first computer 110 engages in a long-term or short-term arrangement for bidding on needed computing capacity or for selling available excess computing capacity with the other computers (120, 130, 140, etc.) in the network. When the first computer 110 bids on needed computing capacity, the first computer 110 provides, via the Internet backbone 115, to the computing capacity marketplace server 100 with a member name (COMPUTER 110), specific quantity of needed computing capacity (QIN), need start time (T1N_S), need ending time (T1N_E), bid price ($B1), executable program and/or data location (LOC1+HD—S) and name (NAME1), and Internet location for post-processing data storage (LOC1+HD—R), as shown in FIG. 1A. The computer 110 transmits this information to the computing capacity marketplace server 100 over the Internet backbone 115. The computing capacity marketplace server 100 then enters each of the received items of information in its proper location in database 105, as shown in FIG. 1A at 111, 113, 117, and 119. When the first computer 110 has a quantity of available excess computing capacity to offer for sale, the first computer 110 transmits, via the Internet backbone 115 to the computing capacity marketplace server 100 the specific quantity of available excess computing capacity (Q1A), available start time (T1A_S), available end time (T1A_E), and ask price ($A1), as shown in FIG. 1A at 110A. The computing capacity marketplace server 100 then enters each of the received items of information in its proper location in database 105, as shown in FIG. 1A at 115.

Similarly, the second computer 120, the third computer 130, and the fourth computer 140, transmit to the computing capacity marketplace server 100, similar information as shown in FIG. 1A at 120A, 130A, and 140A. Such information includes their specific need for additional computing capacity, available excess computing capacity, start times, end times, bid price, ask price, executable program code and/or data location and name, post-processing data storage location, and computer name. This information is received by the computing capacity marketplace server 100 for proper storage in the database 105, as shown in FIG. 1A at 111, 113, 115, 117, and 119.

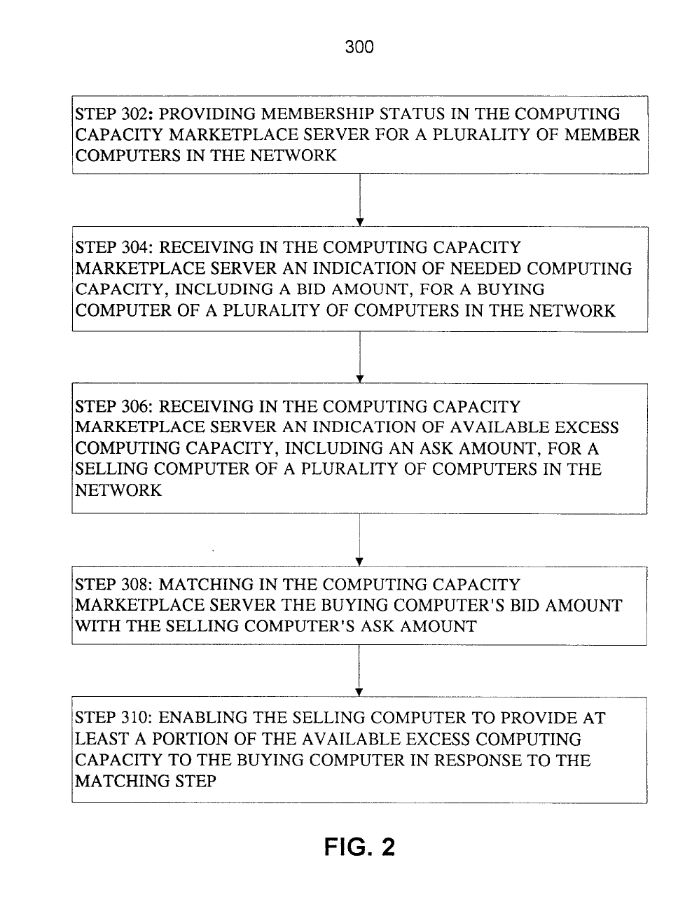

At least two modes of marketplace processing can be carried out by the computing capacity marketplace server 100, that is, either long-term prearranged computer capacity biding and selling or short-term spot market computing capacity biding and selling. The long-term mode of operation was described above. The short-term spot market mode of operation is carried out as follows. As an example, first computer 110 has a long-term specification stored in database 105 of FIG. 1A, of available excess computing capacity. This specification in database 105 states that every Saturday the first computer 110 has 100 Megaflops (i.e., one-million floating point operations per second) of excess computing capacity (Q1A) available over the twenty-four hour period from midnight (T1A_S) to midnight (T1A_S). The first computer 110 has specified an asking price of $100,000 (A$1) for that available computing capacity. Further in this example, second computer 120 does not have a long-term arrangement with the computing capacity marketplace server 100, for either biding or selling computer capacity. However, the second computer 120 is, for the purposes of this example, a payroll computer and on one particular Saturday a partial power outage has occurred and the second computer 120 will not able to process the payroll. The second computer 120 makes a short-term spot market bid by transmitting its needed computing capacity information over the Internet backbone 115 to the computing capacity marketplace server 100, which is stored in database 105 of FIG. 1A. The second computer 120 specifies in database 105 that on that particular Saturday from 12:00 pm (T2N_S) until 6:00 pm (T2N_E), the second computer 120 needs 100 megaflops (Q2N) of computing capacity and is willing to bid $10,000 ($B2) for obtaining that needed computing capacity. The market maker process 104 of the computing capacity marketplace server 100, which is shown in greater detail on the flow diagram of FIG. 2, provides the needed computing capacity (Q2N) to the second computer 120 from the available excess computing capacity (Q1A) which is indicated in the database 105 for the first computer 110. This is done by matching the asking price ($A1) of the first computer 110 with the bid price ($B2) of the second computer 120 as well as comparing the bid price ($B2) with any other asking price ($A3) for any other computer 130 in the network having available computing capacity during the same Saturday time from 12:00 pm (T3A_S) until 6:00 pm (T3A_E). If the market maker process 104 determines that the bid price ($B2) for the second computer 120 is sufficiently high to match or exceed the asking price ($A1) of the first computer 110 for the computing capacity (Q2N) needed by the second computer 120, then the computing capacity marketplace server 100 proceeds as follows. The computing capacity marketplace server 100 will signal the second computer 120 over the Internet backbone 115 that the needed computing capacity (Q2N) has been found at the first computer 110. The computing capacity marketplace server 100 will also signal, over the Internet backbone 115, the first computer 110 that a buyer has been found for the quantity of computing capacity (Q2N) that is specified as being needed by the second computer 120. The second computer 120 may be designated as the buyer and the first computer 110 may be designated as the seller. Further in accordance with the invention, the computing capacity marketplace service 100 can transmit the network address of the first computer 110 to the second computer 120 and can correspondingly transmit the network address of the second computer 120 to the first computer 110, in order to enable the first and second computers 110 and 120 to communicate over the Internet backbone 115, either directly or via the transaction monitoring process 106 of the computing capacity marketplace server 100, as in FIG. 1A. That sequence of communications between the first and second computers 110 and 120 is carried out as follows. During a first interval prior to the beginning of the period of time 12:00 pm (T2N_S) on Saturday, the second computer 120 will identify to the first computer 110 the location (LOC2_S) of the executable program code and data necessary to be downloaded to the first computer 110 in order for the computer 110 to provide the needed computing capacity. Still further, the second computer 120 will indicate to the first computer 110 an Internet location (LOC2_R) where the post-processing data results should be stored by the first computer 110 to enable the second computer 120 to access the post-processing data results at a later time. The computing capacity marketplace server 100 will store the Internet location (LOC2_R) where the post-processing data should be stored in the database 105 for later use, as shown in FIG. 1A at 119. After the executable program code and raw data have been transferred to the first computer 110, when the agreed period begins at 12:00 pm (T2N_S) on Saturday, the first computer 110 commences processing the raw data on behalf of the second computer 120. Upon completion of either the raw data processing by the first computer 110 or the expiration of the agreed ending time (T2N_E), the first computer 110 places the post-processing data results in the Internet location (LOC2_R) provided by the second computer 120, which was previously stored in database 105 at 119 of the computing capacity marketplace server 100. After the first computer 110 places the post-processed data results in the proper Internet location (LOC2_R), the first computer 110 will send a sign-off signal over the Internet backbone 115 to the second computer 120, either directly or through the transaction monitoring process 106 of the computing capacity marketplace server 100. This sign-off is part of a terminating handshake to indicate that the post-processed data results of the first computer 110 have been stored in the Internet location (LOC2_R) designated by the second computer 120, which was previously stored in the database 105 of the computing capacity marketplace server 100.

FIG. 1B is a more detailed functional block diagram of the computing capacity marketplace server 100. The computing capacity marketplace server 100 includes the memory 202 connected by means of the bus 204 to the CPU processor 210, the database storage 105, and the Internet network adapter 208. FIG. 1B shows the various functional modules of the server 100 arranged in an object model. The object model groups the various object-oriented software programs into components which perform the major functions and applications in the server 100. Enterprise Java Beans (EJB) is a software component architecture for servers, which is suitable for embodying the object-oriented software program components of FIG. 1B. A description of E-Commerce server programming applications developed with Enterprise Java Beans is provided in the book by Ed Roman entitled “Mastering Enterprise Java Beans”, published by John Wiley and Sons, 1999. A description of the use of an object model in the design of a web server for E-Commerce applications is provided in the book by Matthew Reynolds entitled “Beginning Commerce”, Wrox Press Inc, 2000, (ISBN: 1861003986). The object-oriented software program components in the object model of memory 202 are organized into a business logic tier 214, a presentation tier 215, and an infrastructure objects partition 222. The business logic tier 214 is further divided into two partitions: an application program objects partition 224 and a data objects partition 226. The Infrastructure objects partition 222 includes object-oriented software program components for the database server interface 230, member session buffer interface 232, system administrator interface 234, and operating system 225.

FIG. 1B shows the presentation tier 215 including an internet interface 220. The presentation tier 215 manages the Hypertext Transfer Protocol (HTTP) user interface with the buying and selling computers 110, 120, etc. A suitable implementation for the presentation tier 215 is with Java servlets to interact with the buying and/or selling computer using the Hypertext Transfer Protocol (HTTP). The Java servlets run within a request/response server, handling request messages from the buying and/or selling computer and returning response messages to the buying and/or selling computer. The Java servlet is a Java object that takes a request as input, parses its data, performs some logic, and then issues a response back to the buying and/or selling computer. The Java servlets are pooled and reused to service many buying and/or selling computer requests. The Internet interface 220, implemented with Java servlets, functions as a web server that communicates with the buying and/or selling computers using the HTTP protocol. The Internet interface 220 accepts HTTP requests from the buying and/or selling computer and passes the information in the request to the visit object 228 in the business logic tier 214. Result information returned from the business logic tier 214 is passed by the visit object 228 to the Internet interface 220, which sends the results back to the buying and/or selling computer in an HTTP response. The Internet interface 220 exchanges data through the Internet network adapter 208 of server 100 with the buying and/or selling computers. Java servlets and the development of web site servers is described in the book by Duane K. Fields, et al. entitled “Web Development with Java Server Pages”, published by Manning Publications Co., 2000.

The business logic tier 214 in FIG. 1B includes multiple instances of the visit object 228, 228′, and 228″. Each buying and/or selling computer that sends a message to the computing capacity marketplace server 100 has a temporary and separate visit object 228, 228′ or 228″ instantiated to represent the visit. The Enterprise Java Bean server can instantiate multiple copies of the visit object component 228, 228′ or 228″ in the business logic tier 214 to handle multiple messages from multiple buying and/or selling computers. Each visit object 228 will buffer buying and/or selling computer's-specific information and maintain a buying and/or selling computer-specific state for the duration of the session with the buying and/or selling computer. Each visitor object 228 is a stateful session bean that will hold the conversational state about the buying and/or selling computer's visit. A stateful session bean is an Enterprise Java Bean that services business processes that span multiple method requests or transactions. The stateful session bean retains state on behalf of an individual buying and/or selling computer. Data received by the computing capacity marketplace server 100 from the buying and/or selling computer and data sent by the computing capacity marketplace server 100 to the buying and/or selling computer will be temporarily buffered in the visitor object 228, 228′ or 228″.

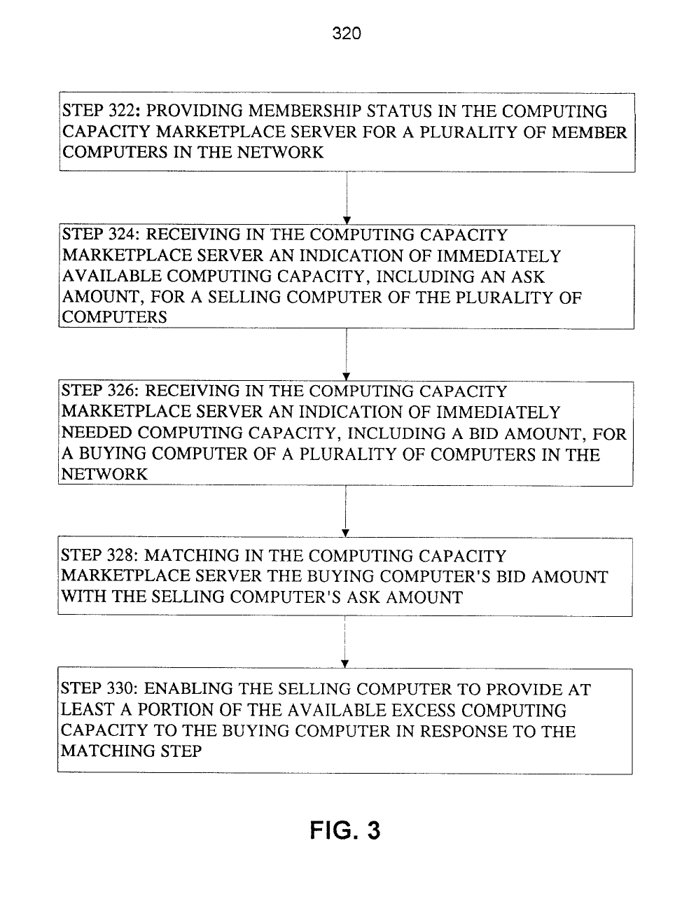

When a HTTP message from a buying and/or selling computer arrives at the computing capacity marketplace server 100 and is received by the Internet interface 220 in FIG. 1B, a visit object 228 is instantiated and the received data is passed to the visit object 228. Depending on the state of the transaction in the flow diagram of FIG. 3, the visit object 228 will send a method call to one of the object-oriented software program components in the application program objects partition 224. If the transaction is that the buying computer has sent an HTTP request message in step 326, indicating needed computing capacity in FIG. 3, then the then the visit object 228 will then send a method call to the market membership process 102 in the server 100 of FIG. 1B. The visit object 228 will then pass the result data, such as an acknowledgement message, back to the Internet interface 220 which will send the result data back to the buying computer. Enterprise Java Beans support transaction processing, where a series of small operations are executed as one large, atomic operation. This allows multiple instantiations of the visitor object 228 representing multiple buying computers to share the same resource component, such as the market membership process 102. When multiple calls are made on a method of the same resource component, the invocations are serialized and performed in lock-step. Any accesses to the database 105 will be handled by the database server interface 230. Any adjustments or updates to the computing capacity marketplace server 100 can be performed by the system administrator through the system administrator interface 234.

The Internet interface object 220 interacts with HTTP messages on the Internet backbone 115. Internet messages exchanged at the Internet interface object 220 are passed to the visit object 228 for interaction with the application program objects in partition 224. Each of the applications shown in the application program objects partition 224 is an object-oriented software program component containing both executable code and data sufficient to carry out the application.

An example software platform for implementing the functions performed by the computing capacity marketplace server 100 of FIG. 1B is the IBM WebSphere Application Server (WebSphere is a trademark of the IBM Corporation.) The WebSphere Application Server is a Java-based Web application platform for managing Java-based E-commerce applications, accessing databases, and handling Internet transactions with remote clients and servers. A description of the WebSphere Application Server is provided in the book by Ron Ben-Natan and Ori Sasson entitled “IBM Websphere Starter Kit”, Osborne McGraw-Hill, 2000 (ISBN: 0072124075). An additional description can be found on the Internet web site: http://www-4.ibm.com/software/developer/library/wsarchitecture/wsarchitecture.html.

As is seen in FIG. 1B, the object model in the memory 202 is divided into three partitions, the infrastructure objects partition 222, the application module objects partition 224, and the data objects partition 226. In the infrastructure objects partition 222, the database server interface component 230 provides the software construct, which transfers information between the server memory 202 and the database storage 105. The member session buffer interface component 232, stores information that is unique to the session being conducted between the server 100 and a particular computer, for example, the first computer 110. As is well known, many Internet protocols, such as the HTTP protocol, are stateless protocols so that each message transfer between a sever and a client will not be remembered the next time a message is received from the client at the server. In order to maintain the state of the session as it continues during a visit of a particular client, for example, the first computer 110 to the computing capacity marketplace server 100, the member session buffer interface component 232 is maintained for the duration of the session. Also included in the object model in the memory 202 of FIG. 1B is the system administrator's interface component 234, which is the software construct which carries the information exchange between the system administrator and the server, whenever changes are made in the application programs or in the data or other software constructs stored in the memory 202.

The application program objects partition 224 includes the market membership process 102, the market maker process 104, and a transaction monitoring process 106, each of which are components which include both executable code as well as data. The market membership process 102 carries out those processing steps necessary to establish a particular computer, for example, computer 10, as a member of the marketplace being formed by the computing capacity marketplace server 100. When the computer 110 signals to the computing capacity marketplace server 100 that it wishes to become a member of the marketplace being established by the computing capacity marketplace server 100, computer 110 transmits need capacity information, available excess capacity information, executable program code and/or data information, and Internet location results information, as required. This information is then stored by the computing capacity marketplace server 100 in the database 105. In the data objects partition 226, a corresponding membership data component 260 buffers the information received from the computer 110, for example, as its being received through the Internet interface component 220, prior to its being provided to the database server interface component 230 for transfer into the database storage 105. A description of the use of an object model in the design of a web server for E-Commerce applications is provided in the book by Matthew Reynolds entitled “Beginning E-Commerce”, Wrox Press Inc, 2000, (ISBN: 861003986).

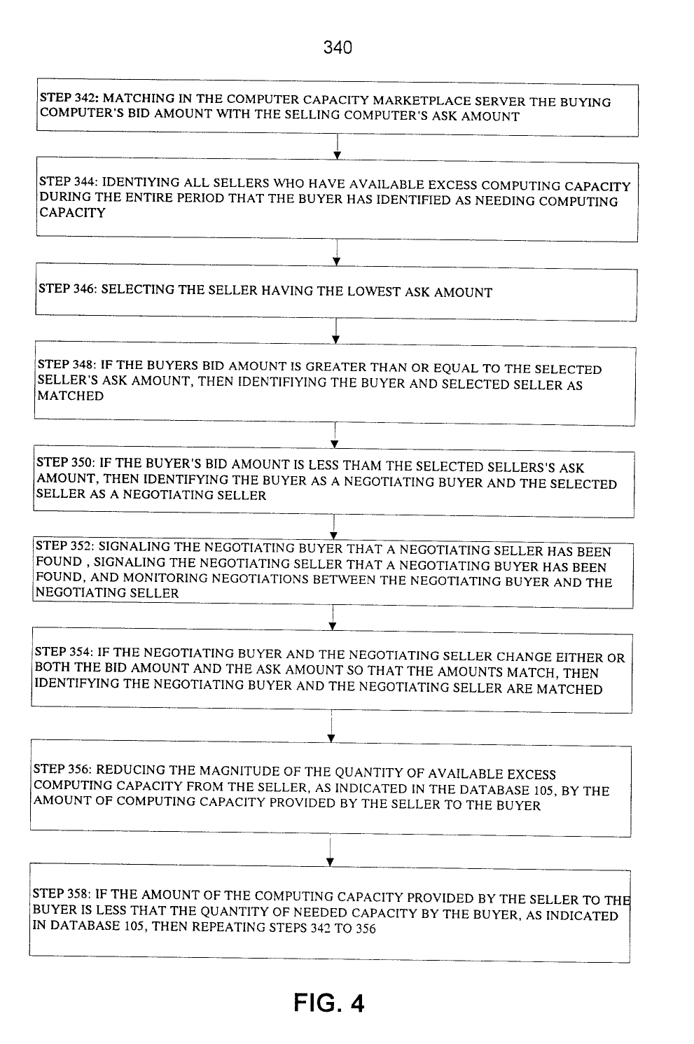

The market maker process 104 is shown in greater detail in the flow diagram of FIG. 2, and in particular in steps 308 and 310. Instep 308 of the flow diagram of FIG. 2, the market server matches a first computer's bid amount with a second computer's ask amount. This process, which is described in greater detail with respect to FIG. 4, can include a communications sequence wherein if the bid price provided in the need capacity information of computer 110, does not match the ask price in the available capacity information of computer 120, for example, then a first communications dialog would be established between the computing capacity marketplace server 100 and the first computer 110 and the second communications dialog would be established between the computing capacity marketplace server 100 and the second computer 120 in order to perform a negotiation to attempt to match the bid price to the ask price. Once the bid price matches or exceeds the ask price, then, the market maker process 104 can complete its step 308 of matching the bid price to the ask price. The market maker process 104 will then transition to step 310 of the flow diagram of FIG. 2, to enable the second computer to provide at least a portion of its available computing capacity to the first computer in response to the matching step. This step can be performed by the computing capacity marketplace server 100 signaling to the first computer 110 and to the second computer 120 that a successful match has been made and that the respective computers can begin their sharing of the excess capacity at the time that they have specified in their respective need capacity and available excess computing capacity portions of the database 105. This would typically conclude step 310 of the flow diagram of FIG. 2.

The transaction monitoring process 106 in the application program objects partition 224 of FIG. 1B, is the process for monitoring the success, failure, or completion of carrying out of the sharing of the available excess computing capacity during the period designated by the two computers in the database 105. A suitable operating system 225 is also included in the memory 202 of FIG. 1B.

The method shown in FIG. 2. Method 300 comprises a process of operational steps 302 to 310 carried out by the computing capacity marketplace server 100 in accordance with the invention. Method 300 includes the following steps. Step 302 provides membership status in the computing capacity marketplace server 100 for a plurality of member computers in the network. Step 304 receives in the computing capacity marketplace server 100 an indication of needed computing capacity, including a bid amount, for a first computer of a plurality of computers in a network. The indication of needed computing capacity can include information such as a start time and an end time for delivery of the needed computing capacity, and a quantity of the needed computing capacity. The quantity of the needed computing capacity can be an amount expressed in units of either floating point operations, web page views, or other suitable units. The method can also be applied, for example, to needed storage capacity or web page mirroring. Step 306 receives in the computing capacity marketplace server 100, an indication of available excess computing capacity, including an ask amount, for a second computer of the plurality of computers. The indication of available excess computing capacity can include a start time and an end time for delivery of the available excess computing capacity, and a quantity of the available computing capacity. Here again, the quantity of the available excess computing capacity can be an amount expressed in units of either floating point operations, web page views, or the like. The invention can also be applied to needed storage capacity. Step 308 matches in the computing capacity marketplace server the first computer's bid amount with the second computer's ask amount. During Step 308, both the selling computer and the buying computer may be locked-out as available selling and/or buying computers pending a successful match. In Step 310, the computing capacity marketplace server enables the second computer to provide at least a portion of the available excess computing capacity to the first computer in response to the matching step.

FIG. 3, is a flow diagram of alternate method of the invention. Method 320 is a process for providing a spot market for computing capacity in a network. It includes the following steps. Step 322 provides membership status in the computing capacity marketplace server for a plurality of member computers in the network. Step 324 receives in the computing capacity marketplace server, an indication of immediately available computing capacity, including an ask amount, for a selling computer of the plurality of computers. Step 326 receives in the computing capacity marketplace server an indication of immediately needed computing capacity, including a bid amount, for a buying computer in the network. Step 328 matches in the computing capacity marketplace server the buying computer's bid amount with the selling computer's ask amount. During Step 328, both the selling computer and the buying computer may be locked-out as available selling and/or buying computers pending a successful match. Step 330 enables the selling computer to provide at least a portion of the available excess computing capacity to the buying computer in response to the matching step.

FIG. 4, is a flow diagram of the steps carried out for matching bid amounts to ask amounts in step 308 of FIG. 2 and Step 328 of FIG. 3. Method 340 comprise the steps as follows. Step 342 identifies all sellers who have available excess computing capacity during the entire time period that the buyer has identified as needing capacity. Step 344 compares the buyer's bid amount with the identified ask amount of each seller. Step 346 selects the seller having the lowest ask amount even if the lowest ask amount is less than the buyer's bid amount. In Step 348, if the buyer's bid amount is greater than the selected seller's ask amount, then the buyer and the selected seller are identified as matched. If the buyer's bid amount is less than the selected seller's ask amount, Step 350 identifies the selected seller as a negotiating seller and identifies the buyer as a negotiating buyer. At that point, Step 352 signals the negotiating buyer that a negotiating seller has been found, signals the negotiating seller that a negotiating buyer has been found, and monitors negotiations between the negotiating buyer and the negotiating seller. Step 354 offers the negotiating buyer and the negotiating seller to change either or both of the bid amount and/or the ask amount so that a match may be made. When and if the negotiations result in the bid amount being greater or equal to the ask amount, then the negotiating buyer and the negotiating seller are identified as matched. Step 356 reduces the magnitude of the quantity of available excess computing capacity identified by the selling computer, as stated in the database 105, by the amount of available excess computing capacity provided by the seller to the buyer. In Step 358, if the amount of available excess computing capacity provided by the seller to the buyer is less than the quantity of needed capacity by the buyer, as stated in the database 105, steps 350 and 356 are repeated.

In addition to the computing capacity marketplace server 100 matching computing capacity, there are other features that the buyer or seller, or both, can specify to be matched. Examples of such other features include: a buyer's preferred seller or group of sellers; a seller's preferred buyer or group of buyers; a buyer's required storage capacity; a seller's available storage capacity; a buyer's requirements for specific types of operating systems compatible with the application program buyer needs to be run (Linux, Windows NT, Unix, etc.); a seller's available types of operating systems (Linux, Windows NT, Unix, etc.); a buyer's requirement for speed; a seller's available speed; the characteristics of a buyer's network interface (broadband, Internet, Intranet, wireless, satellite communications, etc.); and, the characteristics of a seller's available network interface (broadband, Internet, Intranet, wireless, satellite communications, etc.).

Alternatively, negotiations between a negotiating buyer and a negotiating seller can be automatic, for example, where a buyer specifies a range of acceptable ask amounts and/or the seller specifies a range of acceptable bid amounts. In situations where there are two or more buyers and/or two or more sellers, the negotiations between the prospective buyer's and the prospective seller's may be carried out as a regular auction. For example, where two or more buyers are simultaneously seeking available computing capacity from a single seller, the market maker process 104 of the computing capacity market place server 100 would match the seller with the buyer with the highest bid amount stored in database 105 at 113. Conversely, where two or more available sellers are simultaneously offering available computing capacity and only one buyer is available, the market maker process 104 of the computing capacity marketplace server 100 would match the buyer with the seller having the lowest ask amount stored in database 105 at 115.

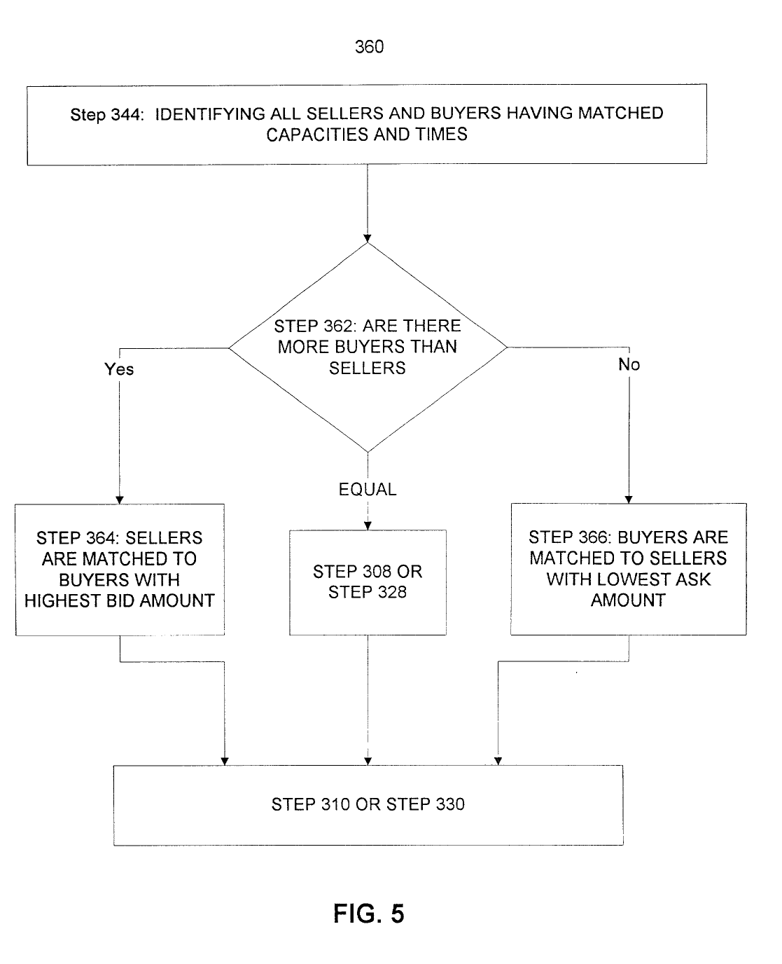

FIG. 5, is a flow diagram of the steps carried out for matching bid amounts to ask amounts in step 308 of FIG. 2 and Step 328 of FIG. 3 when multiple buyers and/or multiple sellers are available. Method 360 comprises the steps as follows. Step 344 of FIG. 4 identifies all available sellers and all available buyers having matched computing capacities, times, etc. Step 362 compares the number of available buyers with the number of available sellers. When the number of available buyers and available sellers are equal, the method proceeds to either Step 308 of FIG. 2 or Step 328 of FIG. 3 where each available buyer will be match with an available seller and then on to Step 310 of FIG. 2 or Step 330 of FIG. 3, respectively. When the number of available buyers is greater than the number of available sellers, the method proceeds to Step 364 where each available buyer with the highest bid amounts stored in database 105 at 113 are matched with a respective available seller. In situations where there are more available buyers than available sellers, some of the available buyers will be unsuccessful with obtaining needed computing capacity at that time. When the number of available sellers is greater than the number of available buyers, the method proceeds to Step 366 where each available seller with the lowest ask amounts stored in database 105 at 115 will be matched with a respective available buyer. In situations where there are more available sellers than available buyers, some of the available sellers will be unsuccessful at selling their available computing capacity at that time. Once the market maker process 105 of the computing capacity marketplace server 100 completes a match in Step 364 or Step 366, the method proceeds to Step 310 of FIG. 2 or Step 330 of FIG. 3, respectively.

Although a particular embodiment has been disclosed, persons of skill in this art will understand that there are alternate embodiments of the invention that are within the scope and spirit of the invention.

What is claimed is:

1. A method of providing a marketplace for computing capacity in a computer network, comprising:
receiving an indication of needed computing capacity, including a bid amount, for a first computer in the computer network;
receiving an indication of available computing capacity, including an ask amount, for a second computer in the computer network;
matching the first computer's need for computing capacity, including the bid amount, with the second computer's available computing capacity, including the ask amount, and;
enabling the second computer to provide at least a portion of said available computing capacity to the first computer in response to said matching step.

2. The method of claim 1, wherein said indication of needed computing capacity further comprises a start time and an end time for delivery of the needed computing capacity.

3 The method of claim 1, wherein said indication of needed computing capacity further comprises a quantity of the needed computing capacity.

4. The method of claim 1, wherein said quantity of the needed computing capacity further comprises an amount expressed in units of either floating point operations or web page views.

5. The method of claim 1, wherein said indication of available computing capacity further comprises a start time and an end time for delivery of the available computing capacity.

6. The method of claim 1, wherein said indication of available computing capacity further comprises a quantity of the available computing capacity.

7. The method of claim 6, wherein said quantity of the available computing capacity further comprises an amount expressed in units of either floating point operations or web page views.

8. The method of claim 1, which further comprises the step of: providing membership status for the plurality of member computers in the computer network.

9. The method of claim 8, wherein the member computers have previously provided said indication of needed computing capacity and said indication of available computing.

10. The method of claim 1, wherein the member computers provide said indication of needed computing capacity and said indication of available computing capacity on a real-time basis for spot market transactions.

11. A system of providing a marketplace for computing capacity in a network, comprising:
a server for receiving an indication of needed computing capacity, including a bid amount, for a first computer in a computer network;
said server receiving an indication of available computing capacity, including a bid amount, for a second computer in the computer network; and
a program in the server, for matching the first computer's need for computing capacity, including the bid amount, with the second computer's available computing capacity, including the ask amount;
whereby the server enables the second computer to provide at least a portion of said available computing capacity to the first computer.

12. A business method of providing a marketplace for computing capacity in a network, comprising:
receiving an indication of needed computing capacity, including a bid amount, for a first computer in a computer network;
receiving an indication of available computing capacity, including an ask amount, for a second computer in the computer network;
matching the first computer's need for computing capacity, including the bid amount, with the second computer's available computing capacity, including the ask amount, and;
enabling the second computer to provide at least a portion of said available computing capacity to the first computer in response to said matching step.

13. A method of providing a marketplace for computing capacity in a computer network, comprising:
receiving an indication of available computing capacity, including an ask amount, for a selling computer in the computer network;
receiving an indication of needed computing capacity, including a bid amount, for a buying computer in the computer network;
matching the buying computer's need for computing capacity, including the bid amount, with the selling computer's available computing capacity, including the ask amount, and;
enabling the selling computer to provide at least a portion of said available computing capacity to the buying computer in response to said matching step.

14. The method of claim 13, wherein the step of matching further comprises:
identifying all sellers who have available capacity during a period that the buyer has identified as needing capacity;
comparing the buyer's bid amount with each identified seller's ask amount;
selecting a seller having a lowest ask amount less than the buyer's bid amount;
if the buyer's bid amount is greater than the selected seller's ask amount, then identifying the buyer and the selected seller as matched;
if the buyer's bid amount is less than the selected seller's ask amount, then identifying the selected seller as a negotiating seller;
signaling the buyer that a negotiating seller has been found, signaling the negotiating seller that a buyer has been found, and monitoring negotiations between the buyer and the negotiating seller;
if the buyer and the negotiating seller change either or both the bid amount and the ask amount so that the amounts match, then identifying the buyer and the negotiating seller as matched.

15. The method of claim 14, which further comprises:
reducing the magnitude of the quantity of available capacity from the seller, by the amount of computing capacity provided by the seller to the buyer.

16. The method of claim 15, which further comprises:
if the amount of computing capacity provided by the seller to the buyer is less than the quantity of needed capacity by the buyer, then identifying another seller who has available capacity during the period that the buyer has identified as needing capacity.

17. A system of providing a marketplace for computing capacity in a computer network, comprising:
a server for receiving an indication of available computing capacity, including an ask amount, for a selling computer in the computer network;
said server receiving an indication of needed computing capacity, including a bid amount, for a buying computer in the computer network; and
a program in the server, for matching the buying computer's needed computing capacity, including the bid amount, with the selling computer's available computing capacity, including the ask amount;
whereby the server enables the selling computer to provide at least a portion of said available computing capacity to the buying computer.

18. A business method of providing a marketplace for computing capacity in a computer network, comprising:
receiving an indication of available computing capacity, including an ask amount, for a selling computer in the computer network;
receiving an indication of needed computing capacity, including a bid amount, for a buying computer in the computer network;
matching the buying computer's needed computing capacity, including the bid amount, with the selling computer's available computing capacity, including the ask amount, and;
enabling the selling computer to provide at least a portion of said available computing capacity to the buying computer in response to said matching step.

19. A computer program product for providing a marketplace for computing capacity in a computer network, comprising:
a computer readable medium;
a computer program code in said computer readable medium, for receiving an indication of available computing capacity, including an ask amount, for a selling computer in the computer network;
a computer program code in said computer readable medium, for receiving an indication of needed computing capacity, including a bid amount, for a buying computer in the computer network;
a computer program code in said computer readable medium, for matching the buying computer's need for computing capacity, including the bid amount, with the selling computer's available computing capacity, including the ask amount, and;
a computer program code in said computer readable medium, for enabling the selling computer to provide at least a portion of said available computing capacity to the buying computer in response to said matching step.

20. A computer program product for providing a marketplace for computing capacity in a network, comprising:
a computer readable medium;
a computer program code in said computer readable medium, for receiving an indication of needed computing capacity, including a bid amount, for a first computer in a computer network;
a computer program code in said computer readable medium, for receiving an indication of available computing capacity, including an ask amount, for a second computer in the computer network;
a computer program code in said computer readable medium, for matching the first computer's needed computing capacity, including the bid amount, with the second computer's available computing capacity, including the ask amount, and;
a computer program code in said computer readable medium, for enabling the second computer to provide at least a portion of said available computing capacity to the first computer in response to said matching step.

21. A system for providing a marketplace for computing capacity in a computer network, comprising:
a server having a processor;
a memory coupled to the processor, the memory having a program stored thereon, wherein the processor can read the program and perform the steps of:
receiving an indication of needed computing capacity, including a bid amount, for a first computer of the computer network;
receiving an indication of available computing capacity, including an ask amount, for a second computer in the computer network;
matching the first computer's needed computing capacity, including the bid amount, with the second computer's available computing capacity, including the ask amount, and;
enabling the second computer to provide at least a portion of said available computing capacity to the first computer in response to said matching step.

22. The system of claim 21 wherein the processor can read the program and perform the further steps of:
providing membership status in the market server for the plurality of member computers in the network.

23. A method of providing a marketplace for computing capacity in a computer network, comprising:
receiving an indication of needed computing capacity for a first computer in the computer network;
receiving an indication of available computing capacity for a second computer in the computer network, and;
enabling the second computer to provide at least a portion of said available computing capacity to the first computer.

24. The method of claim 23, further comprising:
matching the first computer's need for computing capacity with the second computer's available computing capacity.

25. The method of claim 23, wherein said indication of needed computing capacity comprises a bid amount and said indication of said available computing capacity includes an ask amount.

26. The method of claim 23, wherein said indication of needed computing capacity further comprises a start time and an end time for delivery of the needed computing capacity.

27. The method of claim 23, wherein said indication of needed computing capacity further comprises a quantity of the needed computing capacity.

28. The method of claim 23, wherein said quantity of the needed computing capacity further comprises an amount expressed in units of either floating point operations or web page views.

29. The method of claim 23, wherein said indication of available computing capacity further comprises a start time and an end time for delivery of the available computing capacity.

30. The method of claim 23, wherein said indication of available computing capacity further comprises a quantity of the available computing capacity.

31. The method of claim 30, wherein said quantity of the available computing capacity further comprises an amount expressed in units of either floating point operations or web page views.

32. The method of claim 23, which further comprises the step of: providing membership status for the plurality of member computers in the computer network.

33. The method of claim 32, wherein the member computers have previously provided said indication of needed computing capacity and said indication of available computing capacity.

34. The method of claim 23, wherein the member computers provide said indication of needed computing capacity and said indication of available computing capacity on a real-time basis for spot market transactions.

35. A method of providing a marketplace for computing capacity in a computer network, comprising:
receiving an indication of needed computing capacity and first requirements for a first computer in the computer network;
receiving an indication of available computing capacity and second requirements for a second computer in the computer network,
matching the first computer's first requirements with the second computer's first requirements; and;
enabling the second computer to provide at least a portion of said available computing capacity to the first computer.

36. The method of claim 35, further comprising:
said first requirements include a buyer's preferred seller or group of sellers; and
said second requirements include a seller's preferred buyer or group of buyers.

37. The method of claim 35, further comprising:
said first requirements include a buyer's required storage capacity; and
said second requirements include a seller's available storage capacity.

38. The method of claim 35, further comprising:
said first requirements include a buyer's requirements for specific types of operating systems compatible with the application program buyer needs to be run; and
said second requirements include a seller's available types of operating systems

39. The method of claim 35, further comprising:
said first requirements include a buyer's requirement for processor speed; and
said second requirements include a seller's available processor speed.

40. The method of claim 35, further comprising:
said first requirements include the characteristics of a buyer's network interface; and
said second requirements include the characteristics of a seller's available network interface.

41. A method of providing a marketplace for computing capacity in a computer network, comprising:
receiving an indication of needed computing capacity and first negotiating specification for a first computer in the computer network;
receiving an indication of available computing capacity and second negotiating specification for a second computer in the computer network,
matching the first computer with the second computer using the first and second negotiating specifications; and;
enabling the second computer to provide at least a portion of said available computing capacity to the first computer.

42. The method of claim 41, further comprising:
said first negotiating specification includes a buyer specification of a range of acceptable ask amounts;
said second negotiating specification includes s seller specification of a range of acceptable bid amounts.

43. A method of providing a marketplace for computing capacity in a computer network, comprising:
receiving an indication of needed computing capacity and a buyer's bid amount for a first computer in the computer network;
receiving an indication of available computing capacity and a seller's ask amount for a second computer in the computer network,
matching the first computer with the second computer using the bid amount and the ask amount; and;
enabling the second computer to provide at least a portion of said available computing capacity to the first computer.

44. The method of claim 43, further comprising:
matching the seller with the buyer offering the highest bid amount.

45. The method of claim 43, further comprising:
matching the buyer with the seller having the lowest ask amount.
